(19) United States
(12) Patent Application Publication
(10) Pub. No.: US 2014/0049718 A1
(43) Pub. Date: Feb. 20, 2014

(54) Liquid Crystal Display Device

(71) Applicants: Gang Yu, Guangdong (CN); Jiaqiang Wang, Guangdong (CN)

(72) Inventors: Gang Yu, Guangdong (CN); Jiaqiang Wang, Guangdong (CN)

(73) Assignee: SHENZHEN CHINA STAR OPTOELECTRONICS TECHNOLOGY CO., LTD., Guangdong (CN)

(21) Appl. No.: 13/638,897

(22) PCT Filed: Aug. 31, 2012
(86) PCT No.: PCT/CN2012/080833

§ 371 Date: Oct. 1, 2012

(30) Foreign Application Priority Data
Aug. 20, 2012 (CN) 201210296507.7

(51) Int. Cl. G02F 1/1335

(52) U.S. Cl. 349/58

(57) ABSTRACT

The present invention discloses a LCD device. The LCD device comprises a back bezel, a light guide plate on the back bezel for guiding light, an optical film on the light guide plate for processing guided light through the light guide plate, a LCD panel, a n-shaped groove with two parallel surfaces and a first side surface, and a frame with a projecting fixing structure. The two parallel surfaces and the first side surface form n shape, and the n-shaped groove is fastened to a back side of the LCD panel. The fixing structure is capable of engaging in the n-shaped groove to fix a relative position of the LCD panel.

### BACKGROUND OF THE INVENTION

1. Field of the Invention

The present invention relates to a display technology, more particularly, to a liquid crystal display (LCD) device.

2. Description of the Prior Art

LCDs are widely used in modem information equipments such as computers, cell phones, personal digital assistances (PDAs), etc, due to their thin, lightweight, low power consumption features. Generally, an LCD comprises a liquid crystal panel and a backlight module. Since the liquid crystal panel itself does not light, the LCD requires light sources which emit light from the backlight module. Light emitted by the backlight modules passes through liquid crystals in the liquid crystal panel. The intensity of light which would be conveyed to a viewer is adjusted by means of an alignment of the liquid crystals. Subsequently, images are produced.

According to the location of light sources, the backlight module of the LCD device is classified as a side-light type and a direct-light type. For the side-light type backlight module, light sources illuminate the LCD from the side of the display panel. Light produced by the light sources emits to the liquid crystal panel. For the direct-light type backlight module, light sources illuminate the LCD from the bottom of the display panel. Light produced by the light sources emits to the liquid crystal panel.

Please referring to FIG. 1, FIG. 1 shows a structure of a conventional LCD device 100. The LCD device 100 comprises a LCD panel 110, a frame 120, a housing 130, an optical film 140, a light guide plate 150 and a back bezel 160.

The back bezel 160 is used for carrying on the light guide plate 150 for guiding light from a light source, and the optical film 140 on the light guide plate 150 for processing the guided light through the light guide plate 150. The housing 130 is on the optical film 140 and used for pressing the optical film 140 to fix a relative position of the optical film 140.

The LCD panel 110 is carried on by the housing 130 and used for controlling an alignment of liquid crystals according to driving signals from a driving chip to adjust light intensity from the optical film 140 and then displaying images.

The frame 120 is used for fixing a relative position of the LCD panel 110.

Under the above-mentioned structure, however, the LCD panel 110 has to be carried on by the housing 130 and fixed by the frame 120. In hence, such fixing structure with two huge components costs a lot.

Furthermore, consumers' appetite for a LCD monitor in market depends on not only functions and display effects but also attractive appearance. For instance, there is a trend towards narrow frame for a LCD monitor, Therefore, there is a demand of being contracted for a whole module. But, it is still difficult to meet the demands for narrow frame and being contracted under such structure.

Therefore, it is necessary to solve the problem.

### SUMMARY OF THE INVENTION

The present invention provides a LCD device with a new module structure to attach a frame or a back bezel to a back structure of a LCD panel to fix the LCD panel. In hence, the present invention achieves the goals of cost saving and being safer in the process of assembling without arranging a frame and/or a frame. Besides, the design of narrow frame is going to be achieved by the appropriate module plan as well.

According to the present invention, a liquid crystal display (LCD) device comprises: a back bezel; a light guide plate on the back bezel for guiding light; an optical film on the light guide plate for processing guided light through the light guide plate; an LCD panel; an n-shaped groove having two parallel surfaces and a first side surface, the two parallel surface and the first side surface forming an n-shaped structure, wherein the n-shaped groove is attached to a back side of the LCD panel; a frame having a protrusive fixing structure, the fixing structure engaging in the n-shaped groove to fix a relative position of the LCD panel.

In one aspect of the present invention, the LCD device further comprises an adhesive structure locating between the n-shaped form groove and the LCD panel, wherein the n-shaped groove is attached to the back side of the LCD panel by the adhesive structure.

In another aspect of the present invention, an opening of the n-shaped groove is in a horizontal direction to allow the fixing structure to be engaged with the n-shaped groove.

In still another aspect of the present invention, the n-shaped groove further comprises a second side surface perpendicularly connecting to the two parallel surfaces and the first side surface.

In yet another aspect of the present invention, the fixing structure is pushed to a side of the n-shaped groove for the fixing structure engaging in the n-shaped groove.

According to the present invention, an LCD device, comprises: a back bezel having a projecting fixing structure; a light guide plate on the back bezel for guiding light; an optical film on the light guide plate for processing guided light through the light guide plate; an LCD panel; an n-shaped groove having two parallel surfaces and a first side surface, the two parallel surface and the first side surface forming an n-shaped structure, wherein the n-shaped groove is attached to a back side of the LCD panel. The fixing structure is engaged with the n-shaped groove to fix a relative position of the LCD panel.

In one aspect of the present invention, the LCD device further comprises an adhesive structure locating between the n-shaped form groove and the LCD panel, wherein the n-shaped groove is attached to the back side of the LCD panel by the adhesive structure.

In another aspect of the present invention, an opening of the n-shaped groove is in a horizontal direction to allow the fixing structure to be engaged with the n-shaped groove.

In still another aspect of the present invention, the n-shaped groove further comprises a second side surface perpendicularly connecting to the two parallel surfaces and the first side surface.

In yet another aspect of the present invention, the fixing structure is pushed to a side of the n-shaped groove for the fixing structure engaging in the n-shaped groove.

The advantages of the present invention are that the present invention provides a LCD device with a new module structure to attach a frame or a back bezel to a back structure of a LCD panel to fix the LCD panel. In hence, the present invention achieves the goals of cost saving and being safer in the process of assembling without arranging a frame and/or a housing. Besides, the design of narrow frame is achieved by the appropriate module plan as well.

### BRIEF DESCRIPTION OF THE DRAWINGS

For better understanding embodiments of the present invention, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 1 shows a structure of a conventional LCD device.

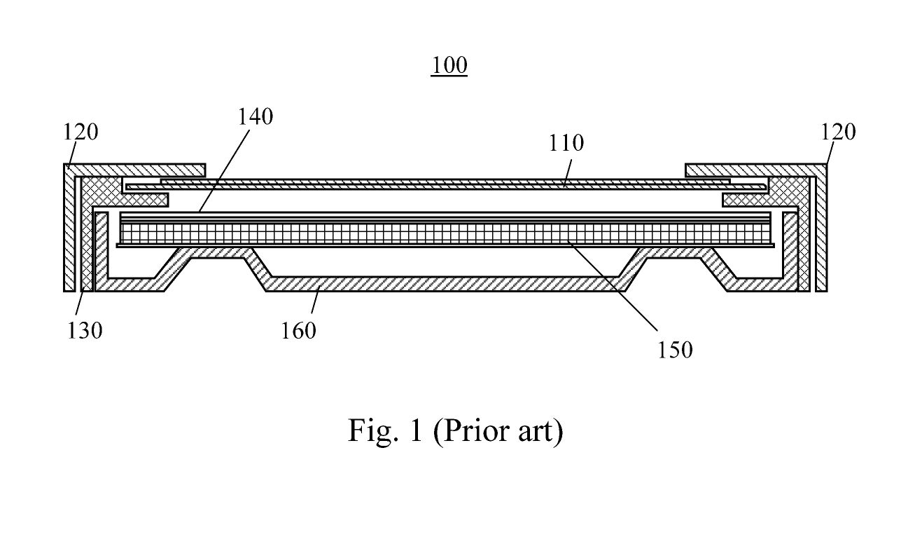

FIG. 2 illustrates a structure diagram of a LCD device according to the first embodiment of the present invention.

FIG. 3 is an enlarged view of the n-shaped groove and the LCD panel.

FIG. 4 illustrates a structure diagram of a LCD device according to a second embodiment of the present invention.

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

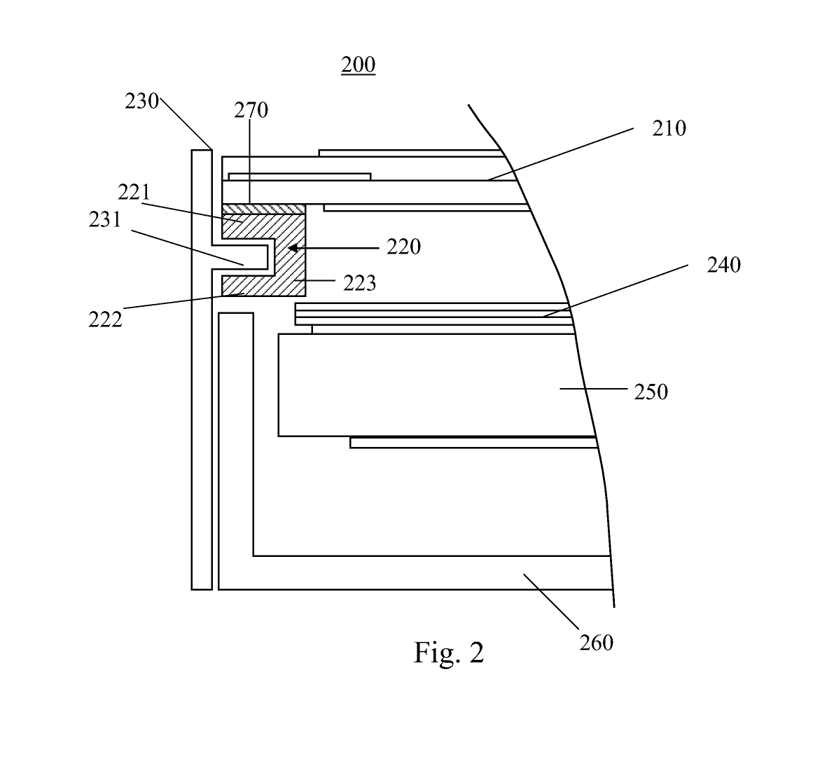

Please referring to FIG. 2, FIG. 2 illustrates a structure diagram of a LCD device 200 according to a first embodiment of the present invention. The LCD device 200 comprises a LCD panel 210, a frame 230, an optical film 240, a light guide plate 250 and a back bezel 260.

The back bezel 260 is used for carrying on the light guide plate 250, used for transmitting light from a light source, and the optical film 240, which is on the light guide plate 250 and used for processing the guided light through the light guide plate 250.

An alignment of liquid crystals is controlled according to driving signal from a driving chip to adjust light intensity from the optical film 240 and then displaying images.

The frame 230 comprises a protrusive fixing structure 231. An n-shaped groove 220 is fastened on the back side of the LCD panel 210. The n-shaped groove 220 is fastened to the LCD panel 210 by an adhesive structure 270. For example, the adhesive structure 270 may be an adhesive to stick the n-shaped groove 220 to the LCD panel 210.

As FIG. 2 shows, the n-shaped groove 220 of the embodiment has two parallel surfaces 221, 222 and a side surface 223. An n-shaped groove with an opening is formed by the two parallel surfaces 221, 222 and the side surface 223. The opening of the n-shaped groove is in a horizontal direction (towards left direction). The fixing structure 231 is engaged with the n-shaped groove 220 to assemble together, so that the relative position of the LCD panel 210 is fixed by the assembly of the fixing structure 231 and the n-shaped groove 220.

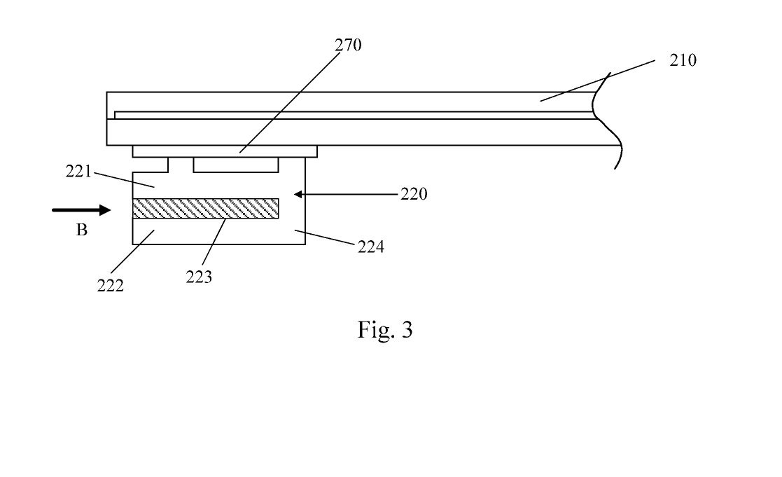

Please referring to FIG. 3, FIG. 3 is an enlarged view of the n-shaped groove 220 and the LCD panel 210. The LCD panel 210 is fastened to the n-shaped groove 220 by the adhesive structure 270. The n-shaped groove has two parallel surfaces 221, 222 and one side surface 223.

In this embodiment, the n-shaped groove comprises another side surface 224 (not shown in FIG. 2) which connects and is perpendicular to the two parallel surfaces 221, 222 and the side surface 223. Therefore, a shape of the n-shaped groove 220 is like drawer, and the fixing structure 231 engages in the n-shaped groove 220 by pushing the fixing structure 231 to the opening (the space) of the n-shaped groove 220 along a direction indicated by Arrow B to assemble so that the LCD panel 210 is fixed.

It is noted that the opening of the n-shaped groove 220 in a horizontal direction is not limited in the present invention. In practical application, there are able to be different structures and directions for the opening of the n-shaped groove 220 if the condition is achieved that structures and directions of the fixing structure 231 fit the n-shaped groove 220 to attach the fixing structure 231 to the n-shaped groove 220 of the LCD panel 210.

In addition, the present invention is not limited by the structure that the fixing structure 231 is a protrusion of the frame 230. Practically, it is also in the scope of the present invention that the fixing structure 231 is protruded out of the back bezel 210 or another component.

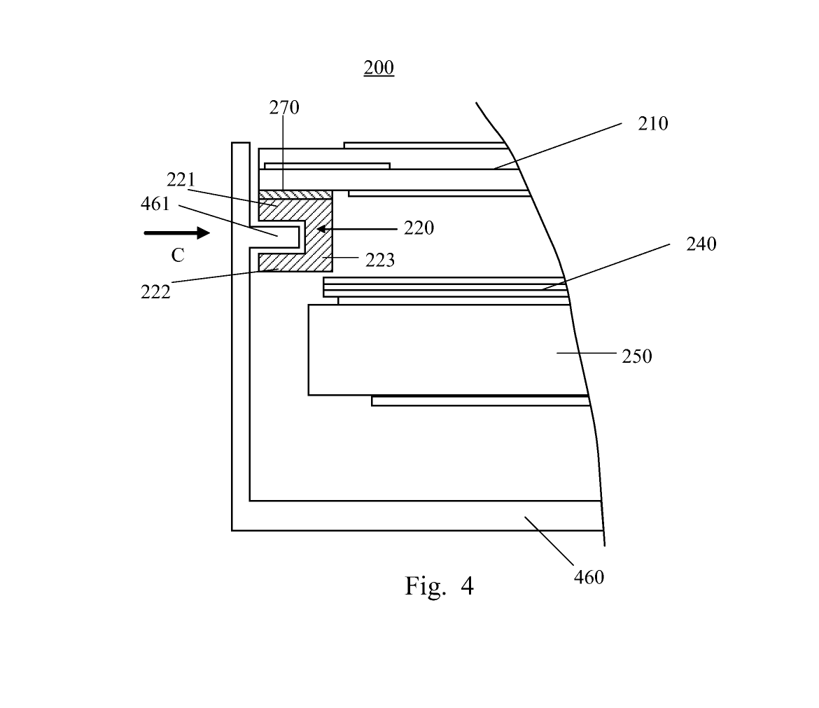

Please refer to FIG. 4. FIG. 4 illustrates a structure diagram of a LCD device 200 according to a second embodiment of the present invention. The LCD device 200 does not comprise a frame but a protrusive fixing structure 461 of a back bezel 460 to be engaged with the n-shaped groove 220 to attach to the n-shaped groove 220 of the LCD panel 210.

The components in FIG. 4 with the same label in FIG. 2 have the same functions and structures, and thus there is no further description for the components.

A structure of the n-shaped groove 220 is similar to a drawer in FIG. 3 as well. The fixing structure 461 engages in the n-shaped groove 220 by pushing the fixing structure 461 toward the opening (the space) of the n-shaped groove 220 along a direction of Arrow C to assemble together so that the relative position of the LCD panel 210 is going to be fixed.

As the above disclosure showed, the present invention is capable of omitting a frame and is likely to leave a housing out so that a LCD panel assembles with a frame/back bezel directly to simplify the module structure and save cost. Besides, it is safer in the process of assembling a LCD panel in such way as well. Furthermore, the design of narrow frame is also achieved by the appropriate module plan without a frame.

Comparing with the prior art, the LCD device with a new module structure in the present invention attach a frame or a back bezel onto a LCD panel to fix the LCD panel. In hence, the present invention achieves the goals of cost saving and being safer in the process of assembling without arranging a frame and/or a frame. Besides, the design of narrow frame is also achieved by the appropriate module plan without a frame.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. A liquid crystal display (LCD) device, comprising:
a back bezel;
a light guide plate on the back bezel for guiding light;
an optical film on the light guide plate for processing guided light through the light guide plate;
an LCD panel;
an n-shaped groove having two parallel surfaces and a first side surface, the two parallel surface and the first side surface forming an n-shaped structure, wherein the n-shaped groove is attached to a back side of the LCD panel;
a frame having a protrusive fixing structure, the fixing structure engaging in the n-shaped groove to fix a relative position of the LCD panel.

2. The LCD device of claim 1 further comprising an adhesive structure locating between the n-shaped form groove and the LCD panel, wherein the n-shaped groove is attached to the back side of the LCD panel by the adhesive structure.

3. The LCD device of claim 1, wherein an opening of the n-shaped groove is in a horizontal direction to allow the fixing structure to be engaged with the n-shaped groove.

4. The LCD device of claim 1, wherein the n-shaped groove further comprises a second side surface perpendicularly connecting to the two parallel surfaces and the first side surface.

5. The LCD device of claim 4, wherein the fixing structure is pushed to a side of the n-shaped groove for the fixing structure engaging in the n-shaped groove.

6. An LCD device, comprising:
a back bezel having a projecting fixing structure;
a light guide plate on the back bezel for guiding light;
an optical film on the light guide plate for processing guided light through the light guide plate;
an LCD panel;
an n-shaped groove having two parallel surfaces and a first side surface, the two parallel surface and the first side surface forming an n-shaped structure, wherein the n-shaped groove is attached to a back side of the LCD panel;
wherein the fixing structure is engaged with the n-shaped groove to fix a relative position of the LCD panel.

7. The LCD device of claim 6 further comprising an adhesive structure locating between the n-shaped form groove and the LCD panel, wherein the n-shaped groove is attached to the back side of the LCD panel by the adhesive structure.

8. The LCD device of claim 6, wherein an opening of the n-shaped groove is in a horizontal direction to allow the fixing structure to be engaged with the n-shaped groove.

9. The LCD device of claim 6, wherein the n-shaped groove further comprises a second side surface perpendicularly connecting to the two parallel surfaces and the first side surface.

10. The LCD device of claim 9, wherein the fixing structure is pushed to a side of the n-shaped groove for the fixing structure engaging in the n-shaped groove.
